(19) United States
(12) Patent Application Publication
(10) Pub. No.: US 2009/0067797 A1
(43) Pub. Date: Mar. 12, 2009

(54) OPTICAL WAVEGUIDE RADIATION CONTROL

(75) Inventor: David R. Peale, San Diego, CA (US)

Correspondence Address: LNG/KLA 2 Joint Customer Number;C/O Luedeka, Neely & Graham, P.C., P.O. Box 1871, Knoxville, TN, 37901, US

(73) Assignee: KLA-TENCOR TECHNOLOGIES CORPORATION, Milpitas, CA (US)

(21) Appl. No.: 11/851,374

(22) Filed: Sep. 6, 2007

(51) Int. Cl. G02B 6/10

(52) U.S. Cl. 385/131

(57) ABSTRACT

An integrated optical planar waveguide chip comprising materials and structures such as substrates, adhesives, capping materials, and waveguide structures which are absorbing at the wavelength of the working radiation.

### BACKGROUND

This application relates generally to optics, and more particularly to planar waveguide integrated optics.

In typical planar optical waveguide systems, light is coupled into the chip at one end from one or more optical beams or waveguides, and often coupled out of the chip at the other end in the same manner. Inevitably, light is spilled from the input source into the waveguide cladding at the inputs to the planar chip. This light may continue to propagate in and along the chip and exit or reflect at the other end of the chip. Since this light did not follow the desired guided paths in the chip, it may propagate and reflect and eventually detrimentally interfere with the desired light signals at either end of the chip.

Optical cross coupling and feedthrough from one waveguide to another within an optical chip, such as an optical planar waveguide, can degrade the performance of the chip. There are many possible sources of stray light within an optical chip. The light may have been spilled from the input fiber, or it may have been scattered out of a waveguide within the chip by a slight defect or other perturbation in the waveguide, or it may have come from a waveguide that was intentionally terminated within the chip.

In some technologies which employ optical planar waveguides (e.g., telecommunications devices and functions), the level of feed through or cross coupling that is normally obtained has not been a limiting factor for the device performance. For example, many telecommunications applications are not materially affected by a loss of about 0.1 dB of light (i.e., 2.3%) within a chip. Typical telecommunications applications require crosstalk levels between waveguides on the order of only −20 to −40 dB (i.e. 1.0% to 0.01%). So the amount of lost light when spread out within the chip is in many cases not sufficient to cause problems with the desired signals.

Certain applications such as, but not limited to, interferometry depend on an optical system having low levels of light coupling between waveguides, or feeding through in an uncontrolled manner between the input to output ends of an optical chip. For example, because of the square-law nature of optical interference, if just 1 part per million (PPM) of errant light intensity recombines with the desired signal, the signal amplitude may be modulated by ±2000 PPM. Because of this, some interferometric applications cannot tolerate crosstalk or feedthrough levels that exceed −70 dB (0.00001%). Such cross coupling and feedthrough produces interference within the system that unacceptably degrades the accuracy and stability of the interference signal being measured by the system.

Further, in certain applications, it is desirable to terminate a waveguide on or within a planar optical chip such that when the waveguide terminates, no forward-propagating light in the waveguide returns in the backwards-propagating direction. This is normally done by gently tapering the waveguide width narrower and narrower until it is essentially non-existent, thereby “releasing” the light mode from the waveguide into the bulk volume of the waveguide cladding and substrate that comprise the chip. Multiple reflections, scatterings, and leakage of the light from the bulk chip typically ensure that most of the light does not find its way back into the terminated waveguide.

However, in the aforementioned high-performance applications, and in cases where a dump guide needs to be present on a single optical chip, the typical “release-launch” method of termination cannot be relied upon to produce acceptable termination and back-coupling performance because too much light from source or dump will bounce around and find its way back into another dump, waveguide or optical I/O port. It is sometimes useful to keep in mind that a good radiator of radiation, such as the tapered waveguide termination, is also an equally good antenna for picking up radiation.

Therefore, there is a need in the art for methods and structures which reduce the amount of wayward light in a planar light circuit, and thereby reduce the amount of cross coupling and feedthrough which may occur between waveguides both internal and external to the chip.

### BRIEF DESCRIPTION OF THE DRAWINGS

FIG. 1A is a schematic side illustration of a structure for beam termination in a planar waveguide.

FIG. 1B is a schematic top view illustration of a structure for beam termination in a planar waveguide.

FIG. 2A is a schematic side view illustration of a planar waveguide chip with optical inputs and outputs illustrating various wayward paths light may take.

FIG. 2B is a schematic, top view illustration of a planar waveguide chip with optical inputs and outputs illustrating various wayward paths light may take.

FIGS. 3A and 3B are schematic illustrations, both side views, not to scale of planar waveguides, according to embodiments.

FIG. 4 is a schematic illustration of an embodiment of a planar waveguide, according to an embodiment.

FIG. 5 is a schematic illustration of an embodiment of a planar waveguide that incorporates an optically dissipative patterned metal layer.

FIG. 6 is a schematic illustration, not to scale of an embodiment of a planar waveguide that incorporates a beam dump and an optically absorbing substrate.

FIG. 7 is a schematic illustration of an embodiment of a planar waveguide that incorporates a beam dump.

FIGS. 8A and 8B are schematic illustrations, side view and top view respectively, of an embodiment of a planar waveguide that incorporates a beam dump.

FIGS. 9A and 9B are schematic illustrations, side view and top views respectively; of an embodiment of a planar waveguide that incorporates a beam dump.

FIGS. 10A and 10B are schematic illustrations, side view and top views respectively, of an embodiment of a planar waveguide that incorporates a beam dump.

### DETAILED DESCRIPTION

Described herein are exemplary systems and methods for improving the signal to noise ratio of integrated optical devices by reducing feedthrough and crosstalk between signals within these devices. The techniques involve reducing the chance of freely launching radiation onto unintended trajectories, and reducing the probability that radiation following unintended trajectories (defined herein as wayward radiation) can recombine with radiation on intended trajectories and alter the amplitudes and phases of signals on the intended paths.

A common theme present in the following embodiments involves radiation which has deviated from the intended path. Such radiation may be referred to as wayward radiation and generally will have traveled along a different path from the intended guided path. Along the errant path, the wayward radiation may have acquired a new phase with respect to the original radiation, and changed in intensity from its origin. Upon rejoining a waveguide (which may even be the same one from which it was lost) the phases and amplitudes of signals within the receiving waveguides can be affected, undermining the integrity of the ultimate observable radiation. Feedthrough is an effect resulting from radiation which was not successfully confined to the intended waveguide upon entering the chip that reaches an optical output of chip. Cross-coupling is an effect resulting from radiation which had been confined for a period of time but was scattered or radiated out of confinement and then rejoined the original or a different waveguide within the chip. To avoid the sometimes subtle distinction, the term wayward radiation is used as a comprehensive superset of the radiations which may cause signal interference.

Throughout this document, terms like light, optical, optics, rays and beams with reference to electromagnetic radiation may be used with no implication that the radiation is or is not in the visible portion of the spectrum. In the following description, numerous specific details are set forth in order to provide a thorough understanding of various embodiments. However, it will be understood by those skilled in the art that the various embodiments may be practiced without the specific details. In other instances, well-known methods, procedures, components, and circuits have not been described in detail so as not to obscure the particular embodiments.

In digital applications, differentiation between high and low states is paramount. In optical systems, just as in other processing, differentiation requires that the lowest high must be higher than the highest low. This is a far less stringent requirement than for analog systems for which the precise intensity and/or phase is the important quantity. To illustrate this, consider a system in which a signal digitizer using a common resolution of twelve bits is used to record the signal intensity. To make full use of this digitizer's capabilities, it is desirable to control the wayward radiation so that outputs are not affected by more than about one part per 4096, or 244 PPM. If this is a coherent system, and we desire to limit the signal interference to 244 PPM, then we need to limit the errant radiation level entering the receiving waveguide to just 0.015 PPM, or −78 dB. Clearly controlling wayward radiation requires more care and attention when building interference-based devices like interferometers than digital systems.

Care should be taken to reduce the amount of radiation released into the integrated optical device. However, as already noted, many devices incorporate terminations which will intentionally release light into the regions surrounding the waveguide cores within the planar chip.

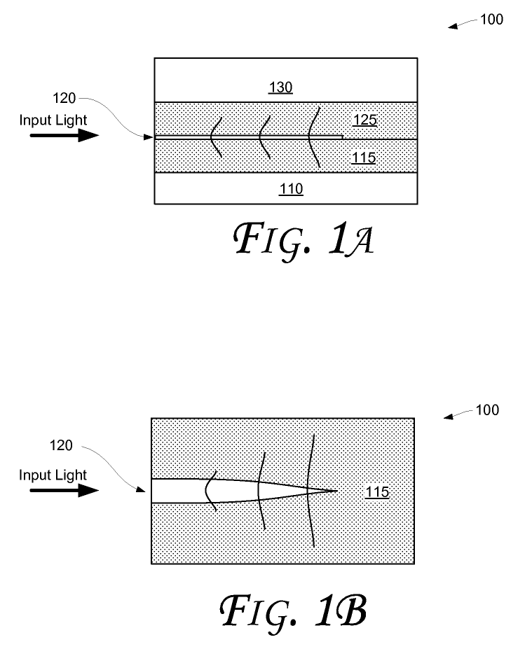

FIG. 1A is a schematic side view illustration of a structure for beam termination in a planar waveguide, and FIG. 1B is a schematic top view illustration of a structure for beam termination in a planar waveguide. In some embodiments, the structure may be implemented as a component on an optical planar waveguide chip. Referring to FIGS. 1A and 1B, a structure 100 comprises a substrate 110, a first, or lower, cladding material 115, a second, or upper, cladding material 125, and a capping material 130. The structure further comprises a core layer 120. In some embodiments the core layer 120 is tapered in at least one dimension. In the embodiment illustrated in FIG. 1B the core layer 120 is tapered in the lateral dimension. As illustrated in FIG. 1B, the confined optical mode profile expands in the lateral dimension as the waveguide core becomes narrower. Depending on the exact waveguide core and cladding dimensions and index values, there may also be a similar expansion of the mode profile in the vertical dimension as well. Light released from such a termination continues to propagate and expand past the end of the waveguide core until it reaches some other boundary within the chip. Such light may represent the source of light following one of many unintended paths within the chip. Similarly, in the reverse situation, such a waveguide termination may represent the receiving endpoint of wayward light from some other source within the chip.

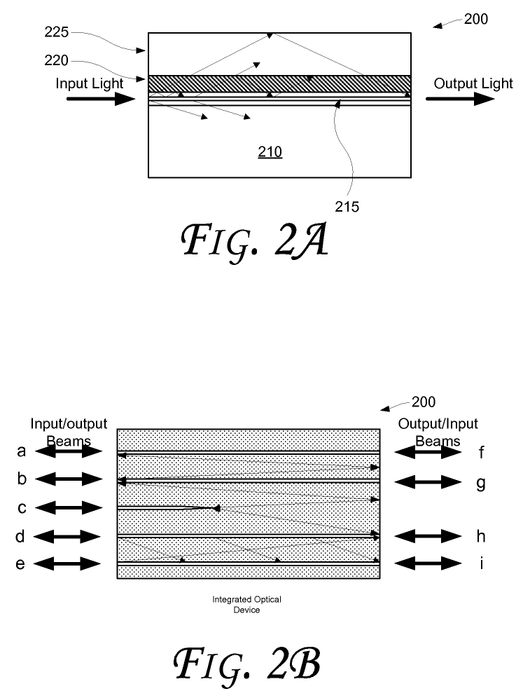

Examples of several representative unintended paths are shown schematically in FIGS. 2A and 2B. FIG. 2A is a schematic side view illustration of a planar waveguide chip 200 with optical inputs and outputs illustrating various wayward paths light may take, and FIG. 2B is a schematic, top view illustration of a planar waveguide chip with optical inputs and outputs illustrating various wayward paths light may take. Straight waveguides are shown for simplicity, but represent whatever complex configuration might exist within a planar waveguide device.

Referring to FIGS. 2A and 2B, a planar waveguide chip 200 comprises a substrate 210, a waveguide core with upper and lower cladding layers collectively indicated by reference number 215, an adhesive layer 220, and a capping material 225. The various arrows in FIGS. 2A and 2B illustrate examples of radiation escaping into the chip volume by failing to couple at the planar waveguide input, by exiting a waveguide somewhere along its length, e.g., by scattering, excessive bending, or simply by being intentionally released at a dump. Such errant radiation may be guided, reflected, and/or scattered at the surfaces of the waveguide cladding layer, the adhesive bonding layer, the substrate or capping layer surfaces, the ends of the chip, or any other interfaces within the chip, or undergo various combinations of any or all of these. Guiding by the cladding or adhesive layers can be particularly troublesome because such guiding preserves a relatively high intensity of the light in the region close to the waveguide core. This increases the chances that significant amounts of the errant light may couple back into a waveguide core or exit beam.

Some amount of radiation will ultimately find its way into the regions surrounding the waveguides. Therefore, it is desirable to suppress this wayward radiation by making the layers carrying the wayward radiation dissipative, i.e., absorbing at the working wavelength of the radiation. For the possibility of wayward radiation being guided by the cladding layer, it is not desirable to make the cladding dissipative because this would make intended mode paths dissipative to the desired signals. Rather, cladding modes can be suppressed and/or made to be dissipative by selectively choosing the real and imaginary index values of the layers adjacent to the cladding. Thus, in one embodiment the substrate, adhesive, and/or capping layers may comprise materials that are dissipative to the light being used. These dissipative materials help absorb any light that is leaked into the chip before it can find its way back into one of the waveguides where it is not wanted. The appropriate materials then depend on the working wavelength.

In one embodiment the working wavelength of radiation is in the infrared region. The working wavelength is the wavelength of radiation that is being used to carry the desired signal, e.g., to make an interferometric measurement. In the infrared, lasers and components are stable, well characterized, and have very high reliability as a result of their widespread use in the telecommunications industry. In some embodiments, the working wavelength is near thirteen hundred and ten nanometers. In some embodiments, the working wavelength is near fifteen hundred and fifty nanometers such as produced by a distributed feedback laser. In other embodiments, such as for molecular spectroscopy, the wavelength may include mid infrared wavelengths from 2 to 30 microns. As waveguides, lasers and components improve, there may be embodiments in the near infrared (780 nm through 1 micron), and the visible wavelength range as well.

In some embodiments, the working wavelength is confined within a single optical mode. This is done by choosing the dimensions of waveguide and the indices of refraction of the core and cladding appropriately. Other, shorter wavelength radiation can be present during operation as long as this radiation is either removed, or does not affect the optical detectors used to produce the desired analog output signals.

In some embodiments the substrate may be comprised of heavily doped silicon, which is absorbing in the infrared, even at wavelengths of 1.55 microns. Dopants may include phosphorus for P-type doping or boron for N-type. Alternate P-type dopants would be As (arsenic), Sb (antimony), or Bi (bismuth). Alternate N-type dopants are: Al, Ga and In (aluminum, gallium, and indium). Dopant ranges in the mid 10̂18 per cubic cm and higher produce significant absorption in the infrared through free carrier absorption over the relevant waveguide path lengths of 200 microns to many millimeters. (See for example absorption vs. carrier concentration data from Spitzer and Fan, Phys Rev 108, 268 (1957).) N-type dopants generally “activate” more efficiently than P-type, so slightly lower N-type doping concentrations produce the same conductivity and absorption as achieved for a given level of P-type doping. By using highly doped Si substrates with the planar waveguide, the portion of light that gets spilled, scattered or dumped from a waveguide into the substrate can be dissipated within the substrate. Such light is absorbed by the silicon before it can reach another waveguide or the other end of the chip.

A capping layer, usually made of glass, is typically bonded to the top of the optical waveguide chip to both protect the thin delicate surface waveguide layers, and to facilitate bonding of the input/output fibers to the edge of the waveguide chip. Typically, this glass is chosen for its good thermal expansion match to the silicon substrate material and not for its optical dissipative properties. Examples included fused quartz and Pyrex, which is generically known as borofloat glass. Since wayward light may also be spilled, scattered or dumped into this capping layer as well as the substrate, the capping layer may also be made from absorbing materials so as to dissipate or absorb the wayward light before it can re-couple into another waveguide or reach the other end of the chip.

For example, the Schott Glass company makes a series of IR absorbing glasses called the “KG” series, e.g. KG-1, KG-2, etc. through KG-5. KG-1 transmits 2-3% of the incident light at wavelengths of 1.5-1.6 microns through a thickness of 1 mm. KG-5 transmits only about 2×10̂-2 to 4×10̂-3% of the light through the same thickness. Likewise, the Hoya glass company makes the series of “Heat absorbing” glasses HA-15 HA-30 and HA-50 etc. More generally, other absorbing materials may also be suitable as capping layers, including the previously mentioned highly doped substrate material, e.g. silicon which has the advantage of providing a perfect thermal expansion match to the waveguide substrate.

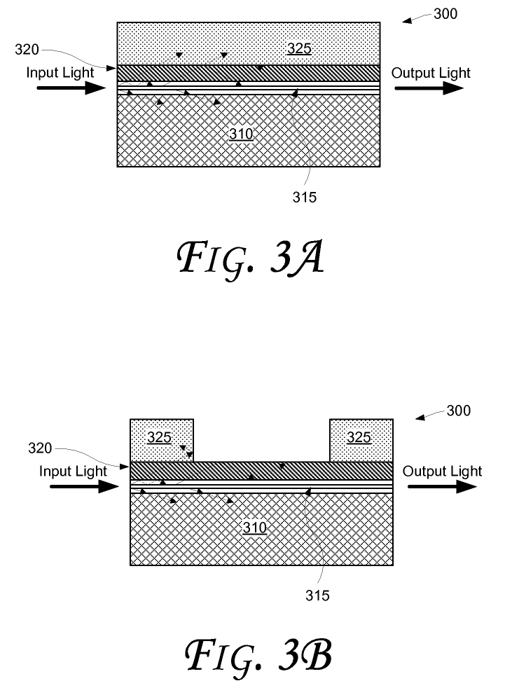

Some embodiments of a chip might not use a single continuous sheet of capping material on the top of the chip. Some practitioners use segments of capping material only at the ends of the chip as shown in FIG. 3B. FIGS. 3A and 3B are schematic side view illustrations of a planar waveguide, according to an embodiment in which the capping material is continuous and discontinuous respectively. Referring to FIGS. 3A and 3B, and optical chip 300 may comprise a substrate 310, a waveguide core and one or more cladding layers identified by reference 315, and adhesive layer identified by reference 320, and a capping layer identified by reference 325. The embodiments depicted in FIG. 3 may employ absorbing substrates (e.g heavily doped silicon) as described with reference to FIG. 2. Further, the same absorbing capping material can be used, or traditional non-absorbing materials can also be used because the segmented capping design breaks the optical path through the capping material. In this case, an absorbing adhesive can be either spread over the full chip length or only under the capping material as convenient.

Depending on how the optical inputs and outputs are attached to the planar waveguide chip, a top capping layer may be completely absent. In this case the absorbing substrate alone may be used. Or, the absorbing substrate and an absorbing top layer such as absorbing adhesive may be used.

As just mentioned above, the absorbing properties of the adhesive used to bond the capping layer to the optical chip also prove to be beneficial for dissipating wayward light. Since the adhesive layer is typically many tens of microns thick, light can remain guided in this layer and go on to re-couple onto another waveguide within the chip or exit the end of the chip and merge with the guided light. Making this adhesive intentionally absorbing to the IR (or other relevant wavelength of light) suppresses light propagation not only within the adhesive layer, but also the cladding layer that it is in contact with. The adhesive can be inherently absorbing, or it may comprise a non-dissipative matrix such as epoxy with an additive such as carbon black to make it absorbing.

Dissipative materials can be chosen or modified to be absorbing at the desired working wavelength. The working wavelength can be different from other wavelengths being used for non-measurement tasks such as alignment. The absorbing materials and thicknesses will be chosen to absorb the working wavelength, but preferably not the other wavelengths which may be present in the waveguide. For example, the absorption coefficient and thickness of the adhesive layer may be tuned so that the layer is transparent enough to view visible light passing perpendicular through the plane of the layer, but be strongly attenuating to light at the working wavelength propagating in the plane of the chip.

These techniques of making the substrate, capping layers and adhesive layers dissipative and/or discontinuous to the working radiation may be used alone or in combination to provide an advantageous level of feedthrough and crosstalk reduction. In some embodiments, at least one of the three layers (substrate, adhesive, and capping material) is made absorbing and provides advantages in the level of wayward radiation absorption. In some embodiments, all three layers are made absorbing and virtually eliminate the participation of radiation which has left a waveguide from affecting the desired output.

### Waveguide Termination

The previous discussion has focused on methods and materials for attenuating wayward radiation that has been released from waveguides by various mechanisms. In some embodiments it may be useful to terminate a waveguide on or within the planar optical chip. Rather than release the radiation from the waveguide into a propagating mode, and then subsequently attenuate that radiation, another preferred embodiment directly attenuates the radiation while it is confined to a waveguide mode.

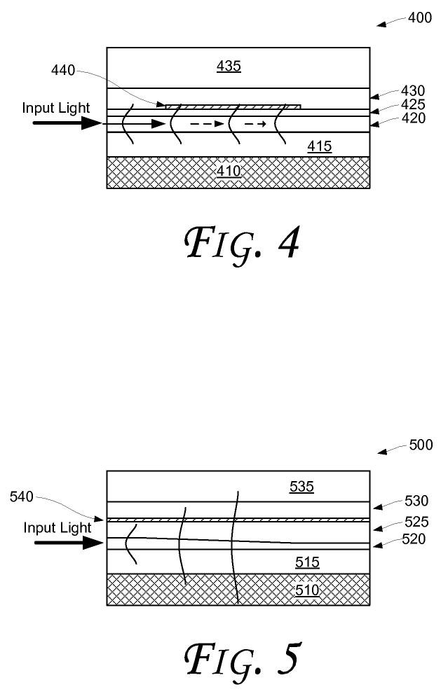

FIG. 4 is a schematic illustration of a planar waveguide that incorporates an optically dissipative patterned material layer, e.g. a metal or metal-oxide film. Referring to FIG. 4, the planar waveguide 400 comprises a substrate 410, a lower cladding layer 415, a core layer 420, and upper cladding layers 425 and 430, a capping material 435, and a dissipating material 440 disposed proximate the upper cladding layer 425. In an embodiment, the dissipating layer 440 comprises a patterned layer of material having selected refractive index values position above or below the waveguide at a separation small enough to cause dissipation of the confined optical mode. Material is present in portions of the waveguide where dissipation of the optical mode is desired. In some embodiments, the sudden change from low loss to absorptive behavior may create back-reflections which may perturb the desired outputs. This may be addressed by angling the metal so that it covers the waveguide obliquely, or by grading the thickness of the metal, making it thinner on the side from which the radiation approaches.

FIG. 5 is a schematic illustration of a planar waveguide that incorporates a beam dump and an optically absorbing metal layer with an incrementally improved structure for reducing the back-reflection created by the presence of the dissipative layer. Referring to FIG. 5, the planar waveguide 500 comprises a substrate 510, a lower cladding layer 515, a core layer 520, and upper cladding layers 525 and 530, a capping material 535, and a dissipating material 540 disposed proximate the upper cladding layer 525. In an embodiment, the dissipating layer 540 comprises a homogeneous material layer which may be applied either above or below the waveguide at a sufficient distance such that substantially no absorption occurs for nominal dimensions of the waveguide. When a beam dump is desired, at least one of the thickness, width and/or index of the waveguide is reduced thereby causing the optical mode to expand vertically. In FIG. 5, as a matter of example, the thickness of the core is shown as being reduced. The optical mode tails expand in the vertical dimension into the thin material layer where the dissipation occurs. By proper choice of the upper cladding thickness and the amount of guided mode expansion, there can be low loss outside the dump regions, and high loss along the dump regions.

Such thin film dissipative material methods have some considerations. For example, (1) the dissipative layer material must be chosen from a limited range of materials, usually metals, which offer suitably dissipative optical constants and are compatible with subsequent processing steps and temperatures; (2) evolution of the metal film composition in time (through effects such as oxidation) can adversely affect the dissipative properties of the film; (3) the magnitude of the dissipation is sensitive to the thickness of the metal layer, and the target thickness of the layer is typically so thin that repeatable deposition thicknesses and index values are difficult to achieve. If the layer is even slightly off-target in thickness or index, the dissipation rate per unit length of dump waveguide changes significantly; (4) the tapered-core method can be difficult because of the extra and sometimes difficult process steps needed to produce a physically or optically tapered waveguide core.

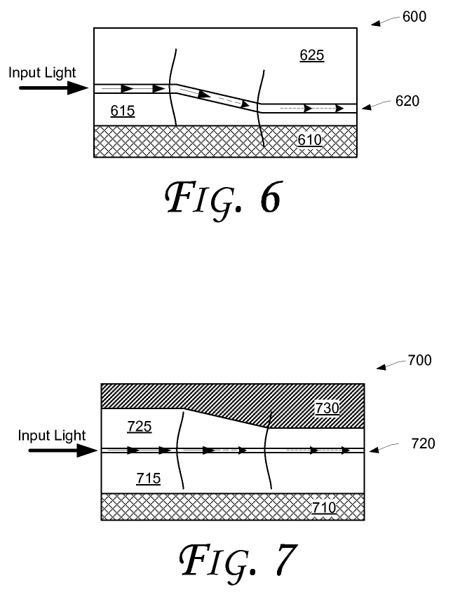

FIG. 6 is a schematic illustration of a planar waveguide 600 that incorporates a beam dump. Referring to FIG. 6, the planar waveguide 600 comprises a substrate 610, a lower cladding layer 615, a core layer 620, and upper cladding layer 625. In the embodiment depicted in FIG. 6, the waveguide is brought closer to an absorbing substrate to create a beam dump. The substrate layer may be made absorbing by the doping techniques discussed earlier. The overlap of the optical mode and the substrate is increased as the separation between the waveguide and the substrate is reduced. The lower cladding layer thickness is changed before the waveguide core is deposited. This eliminates the tapering fabrication steps of the waveguide core and the associated processing complications. Existing oxide etching steps can produce tapered transitions in oxide thickness, but this still involves an extra processing step prior to the deposition of the core material that could adversely affect the quality of the waveguide core. Furthermore, the perturbation of the waveguide mode as the waveguide bends over the changing thickness regions can still cause mode leakage and back-reflections.

FIG. 7 is a schematic side view illustration of a planar waveguide 700 that incorporates a beam dump. Referring to FIG. 7, the planar waveguide 700 comprises a substrate 710, a lower cladding layer 715, a core layer 720, an upper cladding layer 725, and a dissipative material layer 730. In the embodiment depicted in FIG. 6, the waveguide is brought closer. In the embodiment depicted in FIG. 7, the top cladding layer 725 is etched to be thinner over the dump region than over the normal low-loss regions of the waveguide; ideally, there is a smooth transition between these two thicknesses. Consequently there is no dimensional or directional perturbation of the waveguide core capable of producing back-reflections. Neither is there any disturbance of the material upon which the waveguide core is deposited. The region above the top cladding is filled with a suitable dissipative material 730. The optical mode extending beyond the thinned cladding overlaps into the dissipative material and produces the desired dissipative propagation. The index of the top dissipative material may be chosen so as to further encourage the optical mode to be drawn into the dissipative material to provide for even higher dump rates per unit length of waveguide. Because this dissipative material is the last material added to the material stack during fabrication, there is considerably more latitude in the choice for suitable dissipative properties. For example, the dissipative material may be the same absorbing adhesive layer used to bond the capping material as discussed in the previous embodiments.

Despite the fact that the waveguide core has no dimensional or directional perturbations, the effective index of the core can still be subtly perturbed by the change in proximity of the top dissipative material. Such a perturbation can produce relatively weak back-reflections. Consequently, it is advantageous to take steps to make the transition from thick to thin top cladding regions as adiabatically as possible. There are a number of ways to promote such adiabatic transitions and thereby reduce the back-reflections produced.

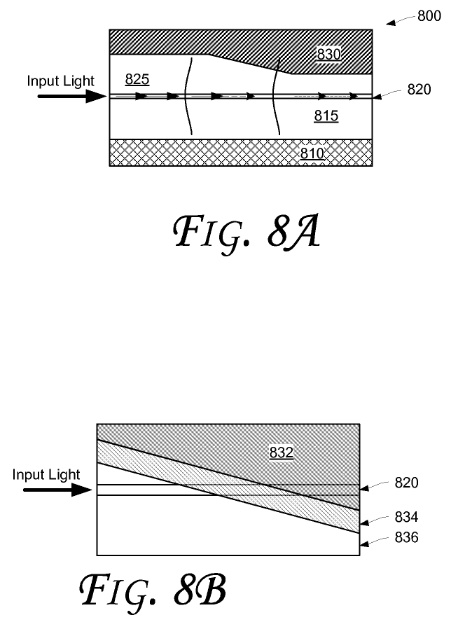

FIGS. 8A and 8B are schematic illustrations, side view and top view respectively, of an embodiment of a planar waveguide 800 that incorporates a beam dump. Referring first to FIG. 8A, the planar waveguide 800 comprises a substrate 810, a lower cladding layer 815, a core layer 820, an upper cladding layer 825, and a dissipative material layer 830. Referring to the top view of FIG. 8B, the thinning transition is formed at an oblique angle with respect to the longitudinal path of the light in the waveguide core, resulting in a first region 832 of a thinned top cladding layer, a second region 834 in which the top cladding layer is in transition, and a third region 836 in which the top cladding layer is full thickness. This angling helps in two ways. It spreads the transition from thick to thin top cladding over a longer length of waveguide thereby making the transition more gradual, and it breaks the lateral symmetry of the transition as seen by the waveguide mode so that any small reflections that might arise tend not to propagate directly back along the input waveguide.

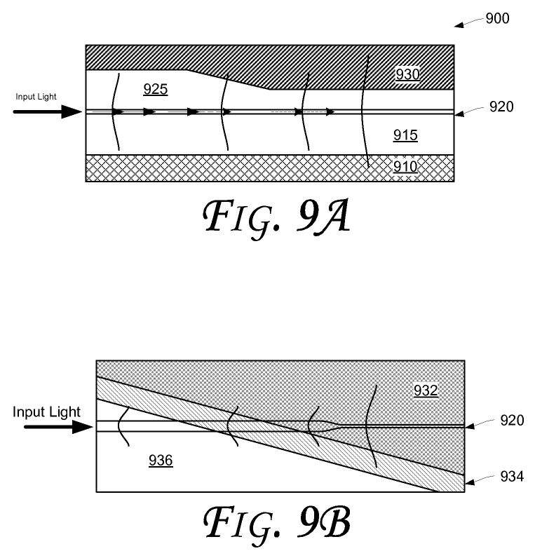

FIGS. 9A and 9B are schematic illustrations, side view and top views, respectively, of an embodiment of a planar waveguide that incorporates a beam dump. Referring first to FIG. 9A, the planar waveguide 900 comprises a substrate 910, a lower cladding layer 915, a core layer 920, an upper cladding layer 925, and a dissipative material layer 930. Referring to the top view of FIG. 9B, the thinning transition is formed at an oblique angle with respect to the longitudinal path of the light in the waveguide core, resulting a first region 932 of a thinned top cladding layer, a second region 934 in which the top cladding layer is in transition, and a third region 936 in which the top cladding layer is full thickness. Further, the lateral waveguide core is tapered in the thin cladding region 932 to encourage the guided mode to expand and increase the overlap in the dissipative layers (the doped substrate below and the upper dissipative material above). This increases the loss rate of the waveguide, thereby shortening the length of waveguide needed to effect “complete” dumping of the radiation.

In step-index waveguides in which the waveguide core is a different material which has been deposited and patterned to define the waveguide, lateral tapers can be made by the same lithographic steps that define the waveguide in the first place. Therefore they are generally easier to produce in a controlled adiabatic fashion than vertical thickness tapers of the waveguide core. Therefore, back-reflections can be more easily controlled in the case of lateral tapers. Depending on the designed width, height and index values of the waveguide core, a lateral taper may not produce as much of a modal size increase in the vertical direction as a proportionally similar thickness taper, however the mode does still increase in size vertically. So it is an effective enhancement of the dump process.

In gradient-index waveguides in which the waveguide core is defined by such processes as flame pyrolysis, ion implantation, ion in-diffusion or diffusive ion exchange, a modal size increase may be created by changing various process parameters which control the core index and/or gradient. The overall effect however is the same in that the mode in the waveguide is encouraged to increase in size so that it overlaps with the dissipative material in the dump region.

The upper and/or lower cladding thickness may be selected such that no thickness change is needed, and only a waveguide taper is used to cause the guided mode to expand into the dissipative material. If the taper transitions to a smaller, but finite core dimension, the mode is still guided but becomes lossy. In this way, wayward light is never created. If the taper reduces the core dimension to zero, this would approach the release-launch paradigm of waveguide termination except that now we are releasing the mode to propagate within a dissipative environment which would quickly absorb the light instead of allowing it to propagate throughout the volume of the chip.

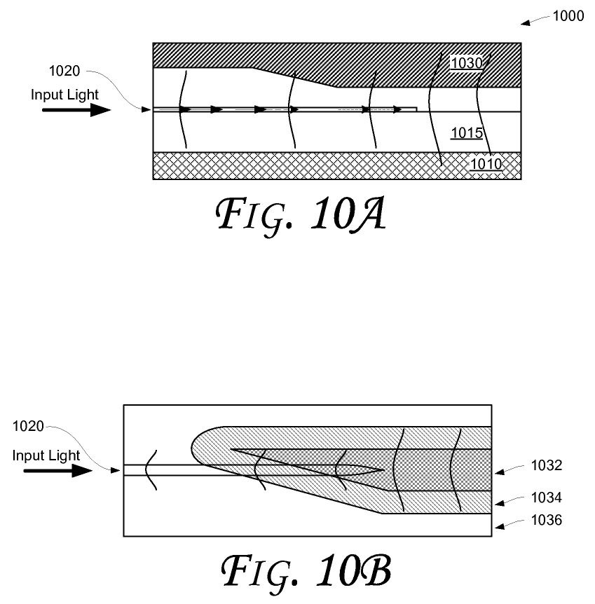

FIGS. 10A and 10B are schematic illustrations, side view and top views respectively, of an embodiment of a planar waveguide that incorporates a beam dump. Referring first to FIG. 10A, the planar waveguide 1000 comprises a substrate 1010, a lower cladding layer 1015, a core layer 1020, an upper cladding layer 1025, and a dissipative material layer 1030. Referring to the top view of FIG. 10B, the thinning transition is formed at an oblique angle with respect to the longitudinal path of the light in the waveguide core, resulting a first region 1032 of a thinned top cladding layer, a second region 1034 in which the top cladding layer is in transition, and a third region 1036 in which the top cladding layer is full thickness.

Furthermore, referring to FIG. 10B, if the upper cladding is etched in the form of a channel over the core, and the dissipative material in that channel has a higher index than the cladding material, then the effect of that channel is to create lateral confinement of the light as it is dissipated. This again helps prevent the light from becoming truly “wayward”.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An integrated optical planar waveguide chip, comprising:
a substrate; and
at least one patterned optical waveguide circuit, in layered proximity to the substrate, to conduct radiation at a working wavelength and fabricated in layered proximity to an absorbing material, wherein the absorbing material is in excess of 1 micron thick, the absorbing material having an absorption coefficient of at least 5 cm−1 at the working wavelength.

2. The planar waveguide chip of claim 1, wherein the substrate comprises a material which absorbs radiation at the working wavelength.

3. The planar waveguide chip of claim 2, wherein the substrate is formed from a semiconductor comprising at least one of: Si, SiGe, GaAs, GaAsP, InGaAs, InGaAsP.

4. The planar waveguide chip of claim 1, wherein the substrate comprises silicon doped to have an absorption coefficient of at least 5 per cm at the working wavelength.

5. An integrated optical planar waveguide chip comprising:
a patterned optical waveguide circuit for conducting radiation at a working wavelength;
a substrate having an absorption coefficient of at least 5 cm−1 at the working wavelength; and
at least one material layer in excess of 1 micron thick over the patterned waveguide circuit having an absorption coefficient of at least 5 cm−1 at the working wavelength of the radiation.

6. The planar waveguide chip of claim 5, wherein at least one of the material layers have absorption and thermal expansion properties within a known value of a glass from the group consisting of Schott Glasses: KG-1, KG-2, KG-3, KG-4, KG-5, Hoya Glasses: HA-15, HA-30, and HA-50.

7. The planar waveguide chip of claim 5 wherein at least one of the material layers is formed from the same material as the absorbing substrate.

8. The planar waveguide chip of claim 5 wherein at least one of the material layers comprises an adhesive which absorbs radiation at the working wavelength.

9. The planar waveguide chip of claim S wherein the at least one material layers comprises:
an adhesive which is transparent to radiation at the working wavelength; and
an additive which is absorbing at the working wavelength.

10. (canceled)

11. (canceled)

12. (canceled)

13. (canceled)

14. (canceled)

15. (canceled)

16. (canceled)

17. (canceled)

18. (canceled)

19. (canceled)

20. The planar waveguide chip of claim 1, wherein the working wavelength is in the infrared region.

21. The planar waveguide chip of claim 1, wherein the working wavelength is within a known value of thirteen hundred and ten nanometers.

22. The planar waveguide chip of claim 1, wherein the absorbing material comprises a first segment of known dimensions placed at a first end of the patterned optical waveguide circuit and a second segment of known dimensions end placed at a second end of the patterned optical waveguide circuit.

23. The planar waveguide chip of claim 22, wherein an adhesive couples the absorbing material segments and the patterned optical waveguide circuit, and the adhesive is present only between the absorbing material segments and the patterned optical waveguide circuit.

24. The planar waveguide chip of claim 22, wherein an adhesive couples the absorbing material segments and the patterned optical waveguide circuit, and the adhesive is present over the patterned optical waveguide circuit.

25. The planar waveguide chip of claim 5, wherein the working wavelength is in the infrared region.

26. The planar waveguide chip of claim 5, wherein the working wavelength is within a known value of thirteen hundred and ten nanometers.

27. The planar waveguide chip of claim 5, wherein the absorbing material comprises a first segment of known dimensions placed at a first end of the patterned optical waveguide circuit and a second segment of known dimensions end placed at a second end of the patterned optical waveguide circuit.

28. The planar waveguide chip of claim 27, wherein an adhesive couples the absorbing material segments and the patterned optical waveguide circuit, and the adhesive is present only between the absorbing material segments and the patterned optical waveguide circuit.

29. The planar waveguide chip of claim 27, wherein an adhesive couples the absorbing material segments and the patterned optical waveguide circuit, and the adhesive is present over the patterned optical waveguide circuit.
